(19) United States
(12) Patent Application Publication
(10) Pub. No.: US 2010/0131551 A1
(43) Pub. Date: May 27, 2010

(54) SYSTEM AND METHOD FOR MANAGING CONFIDENTIAL INFORMATION

(75) Inventors: Alain BENZAKEN, Stamford, CT (US); Gregg DONOVAN, New York, NY (US); Selena HADZIBABIC, London (GB)

Correspondence Address: PILLSBURY WINTHROP SHAW PITTMAN, LLP, P.O. BOX 10500, MCLEAN, VA, 22102, US

(73) Assignee: THELADDERS.COM, INC., New York, NY (US)

(21) Appl. No.: 12/621,100

(22) Filed: Nov. 18, 2009

Related U.S. Application Data
(60) Provisional application No. 61/116,217, filed on Nov. 19, 2008.

(51) Int. Cl. G06F 7/10; G06F 17/30; G06F 3/01

(52) U.S. Cl. 707/769; 707/802; 715/760; 707/E17.044; 707/E17.014; 707/E17.008; 715/810

(57) ABSTRACT

In various embodiments, a computer-implemented method and system of designating and/or protecting confidential information in an original document includes receiving a file containing the original document through a computer-network interface. The original document contains confidential information, and the original document may be stored in one or more structured databases configured in one or more memories. A user interface is provided between the processor and the user associated with the original document. The user identifies at least a portion of the information considered to be confidential through the user interface. The processor may identify each occurrence of the confidential information contained in the original document, and may selectively generate one or more redacted or confidential files in which each occurrence of confidential information in the original document is obscured or redacted. The user may select to not have any confidential information redacted. The redacted files may be stored in one or more structured databases such that the redacted files are available for selective retrieval by the original user and/or a different user.

### CROSS-REFERENCE TO RELATED APPLICATIONS

This application claims benefit under 35 U.S.C. §119(e) to U.S. Provisional Application Ser. No. 61/116,217 filed on Nov. 19, 2008, the entire contents of which are incorporated herein by reference.

### BACKGROUND

The use of Internet or Web-based applications and services has greatly expanded over the last several years. For example, there are several Web-based employment services in which job applicants and potential employers or their intermediaries may exchange job-related information and documents.

One problem with the use or exchange of such documents is related to maintaining confidentiality of personal information by job applicants using the service. For example, a job seeker may not wish for their current employer to know that they are looking for a new job. Confidential information may include the applicant's name, address, current employer, and/or past employers. Other information may be considered “confidential” by the applicant/user, depending on their particular situation, and the relative ease with which the information could be used to ascertain the person being described. However, conventional approaches to online resume posting may allow a recruiter to breach a desired level of confidentiality by allowing the recruiter to inadvertently contact an employer to request confirmation of current employment status without explicit permission from the job applicant.

A problem with one conventional approach to maintaining confidentiality of personal job applicant information is with the use of so-called “field blocking” that may use hypertext markup language (HTML) or other techniques, for example, to place an opaque image in front of confidential applicant information on a document. However, the underlying text may still exist in the document, thus posing the risk of a potential breach of confidentiality.

Further, conventional approaches may not allow the job applicant to designate additional resume information beyond name, address, or current employer as being “confidential”, thus allowing information concerning the applicant to be known to others viewing and/or searching the resume system, including the current employer.

What is needed then, is a system and method for ensuring that confidential job applicant information is maintained in a confidential manner without being subject to premature disclosure. What is further needed is a system and method that allows a job applicant or other person posting personal information to designate selected information as confidential and unavailable for viewing and/or searching by a third party.

### SUMMARY

In one embodiment, a computer-implemented method of designating and/or protecting confidential information in an original document includes receiving a file containing the original document through a computer-network interface. The original document may contain various types of confidential information. The original document may be stored in one or more structured databases configured in one or more memories operatively coupled to the computer-network interface through at least one processor. A user interface may be provided between the at least one processor and the at least one user associated with the original document. The user may selectively identify at least a portion of the information considered to be confidential through the user interface. The processor may be configured to identify each occurrence of the confidential information contained in the original document and to generate one or more redacted files in which each occurrence of the confidential information in the original document may selectively be obscured. Any redacted files generated may be stored in one or more structured databases such that the redacted files are available for selective retrieval by a user as well as a different user. In other aspects of this embodiment, the user may opt for all “confidential” information to be disclosed and remain unredacted.

In another embodiment, a computer-implemented system for designating and/or protecting confidential information in an original document includes at least one processor. A computer-network interface may be operatively coupled to the at least one processor and configured to receive a file containing the original document from at least one user via a computer network. The original document may contain different types of confidential information therein. One or more memory devices may be operatively coupled to the at least one processor and a memory device may include one or more structured databases configured to store at least the original document as well as redacted documents. A user interface may be operatively coupled to the at least one processor, and the user interface may be configured to provide, to the at least one processor, one or more inputs from the at least one user associated with the original document. The one or more inputs may identify at least a portion of the confidential information contained in the original document. The at least one processor may be configured to identify each occurrence of the confidential information contained in the original document, generate one or more redacted files in which said each occurrence of the confidential information in the original document may selectively be obscured, and store any generated redacted files in a structured database such that said the redacted files are available for selective retrieval by user and a different user via the computer network.

In another embodiment, a computer-implemented document browser application for designating and/or protecting confidential information in an original document by a user includes a processor configured to execute instructions therein such that a software interface with an Internet Web browser enables the application to run within a Web browser window. A user interface may be enabled with a host computer system through which the user may selectively input and/or select one or more keywords representing associated confidential information in the original document. The user interface may include computer executable code therein which, when executed by the host computer system, enables a interactive graphical user interface comprising controls for selectively entering and/or selecting said one or more keywords.

### BRIEF DESCRIPTION OF THE DRAWINGS

Various exemplary embodiments of this disclosure will now be described with reference to the accompanying drawings in which:

FIG. 1 illustrates an embodiment of a computer-implemented system for designating and/or protecting confidential information in an original document;

FIG. 2 depicts a screenshot of a document displayed in a web browser in which certain confidential information is obscured;

FIG. 3 depicts a screenshot of the document of FIG. 2 displayed in a web browser in which additional confidential information is obscured;

FIG. 4 depicts a screenshot of a different document page displayed in a web browser in which different confidential information is obscured;

FIG. 5 provides a block diagram of a system for managing confidential information implemented over a computer network.

### DETAILED DESCRIPTION

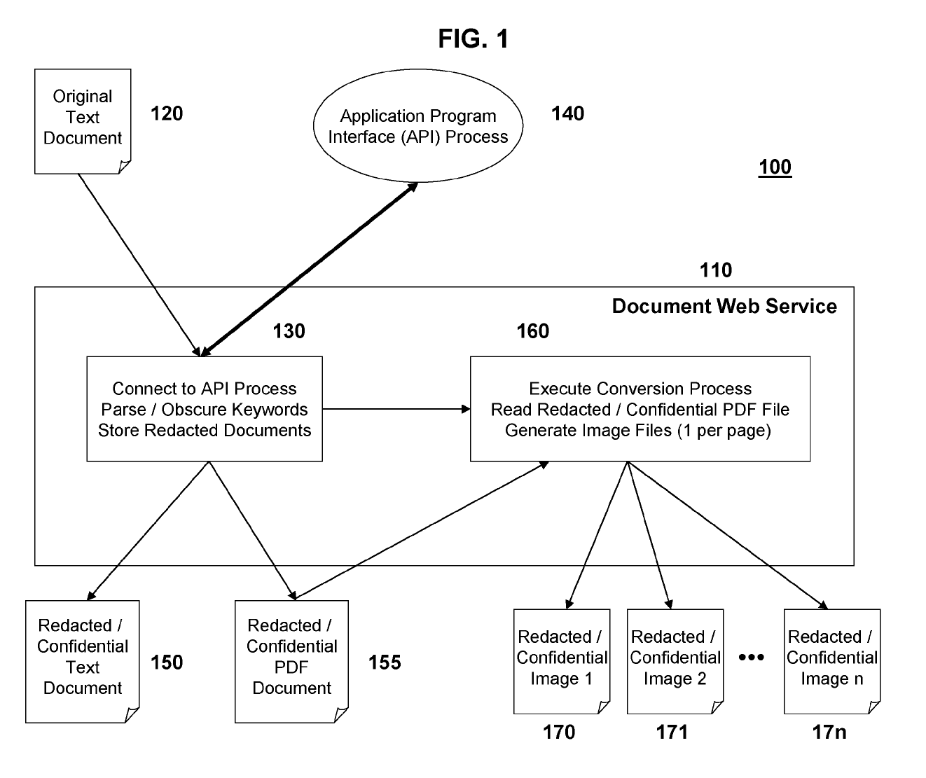

Turning now to FIG. 1, an embodiment of confidential information management system 100 includes document Web service 110 which may be implemented in a personal computer (PC), more specialized server hardware, or by a workstation. In this context, a “computer” is intended to have a broad definition that includes various devices with data processing capability, such as mobile phones, electronic paper/readers, personal data assistants (PDA), and tablet or laptop PCs, for example. Web service 110 may be implemented in a Java environment i.e., as a Java virtual machine (JVM). A Java Virtual Machine (JVM) is a set of computer software programs and data structures which use a virtual machine model for the execution of other computer programs and scripts. The model used by a JVM accepts a form of computer intermediate language commonly referred to as Java bytecode. Other programming and architecture types may be used, as the choice of language does not limit the inventive concept described herein.

Original document 120, e.g., a text document which may be a resume from a job applicant, may be provided to Web service 110 via a network connection (not shown). Original document 120 may be in any standard word processing or text format, e.g., Word® or WordPerfect® format. Redaction process 130 is configured to receive original text document 120. Using an appropriate application program interface (API) process, previously identified keywords representing confidential information may be parsed/identified in original document 130, and then processed to obscure or redact the selected keywords. Obscuration may be accomplished using the API to identify the keywords, replace the keywords with a non-sensical text string such as “XXXXXXX”, for example. Further, in addition to the replacement of confidential text or keywords with one or more text strings, an opaque image may also be superimposed on the text string to ensure that confidential information is, in fact, redacted.

An application API is known to be a set of functions, procedures, methods, classes or protocols that an operating system, library or service provides to support requests made by computer programs. One example of an API or API process is the OpenOffice process available through the website “www.openoffice.org”. OpenOffice is a free cross-platform office application suite available for a number of different computer operating systems. It supports the ISO/IEC standard OpenDocument Format (ODF) for data interchange as its default file format, as well as Microsoft Office formats, among others

The resulting redacted or “confidential” document may be stored both as a confidential/redacted text document 150 and as a redacted/confidential image type document, e.g., in a portable document format (PDF) 155. PDF is a file format created by Adobe Systems for document exchange, and is used for representing two-dimensional documents in a manner independent of the application software, hardware, and operating system. In one or more aspects of this embodiment, it is possible for a user to elect that no confidential information be redacted and/or obscured in their document, e.g., a resume.

It is possible that the job applicant may initially desire to maintain confidentiality of his name and/or other related information, but as the job search process proceeds over time, the job applicant may wish to allow all contact information to be available to prospective employers and/or recruiters. Depending on the rules governing provision of this service, an upgrade in the subscription service may be necessary, at additional cost to the job applicant, for example. Additionally, in one aspect of an embodiment, the user may identify or select at least a portion of the information considered to be confidential through a user interface, whereas in another aspect, the system may determine a portion of the information considered to be confidential using one or more computer-determined default types of information, e.g., the job applicant's name may be considered confidential by default.

Redacted documents 150 and 155 may be stored in conventional ways, including in a structured database in a computer memory (not shown). A data structure in computer science is a way of storing data in a computer so that it can be used efficiently, and is an organization of mathematical and logical concepts of data. Choice of the data structure can allow an efficient algorithm to be used. A well-designed data structure allows a variety of operations to be performed, using as few resources, both execution time and memory space, as possible. Data structures may be implemented by a programming language as data types and the references and operations they provide.

Further, redacted documents 150 and 155 may be stored using conventional network objects, e.g., a Universal Network Objects (UNO) model. UNO is the component model used in OpenOffice.org, and is interface-based and designed to offer interoperability between different programming languages, object models and machine architectures, on a single machine, within a LAN or over the Internet. In one embodiment, the OpenOffice UNO Java API may be used.

Conversion process 160 may be configured to read the redacted/confidential image file (e.g. PDF file 155), and to generate one or more redacted image files (one per page of confidential document 155) 170, 171, and . . . , 17n, where “n” is determined by the number of pages of redacted document 155. Redacted image files 170-17n may be converted to bit-mapped image files. Conversion process 160 may be implemented using, for example, ImageMajick®. ImageMagick® is free software delivered as a ready-to-run binary distribution or as source code that may be freely used, copied, modified, and distributed, and it runs on all major operating systems. ImageMajick® is a software suite used to create, edit, and compose bitmap images. It has the ability to read, convert and write images in a variety of over 100 formats including DPX, EXR, GIF, JPEG, JPEG-2000, PDF, PhotoCD, PNG, Postscript, SVG, and TIFF. ImageMagick® may be used to translate, flip, mirror, rotate, scale, shear and transform images, adjust image colors, apply various special effects, or draw text, lines, polygons, ellipses and Bézier curves, for example. In one embodiment, the functionality of ImageMagick® may be utilized from programs written in a programming language, e.g. JMagick for Java applications. Using a language interface, ImageMagick® may be used to dynamically modify or create images, e.g. redacted image files 170-17n, which may be stored in any desired image file format, e.g., in a bit-mapped file format such as a portable network graphics (PNG) format.

PNG is a bitmapped image format that employs lossless data compression. PNG was created to improve upon and replace GIF (Graphics Interchange Format) as an image-file format not requiring a patent license. Further, PNG supports palette-based (palettes of 24-bit RGB colors), greyscale or RGB images, and was designed for transferring images on the Internet.

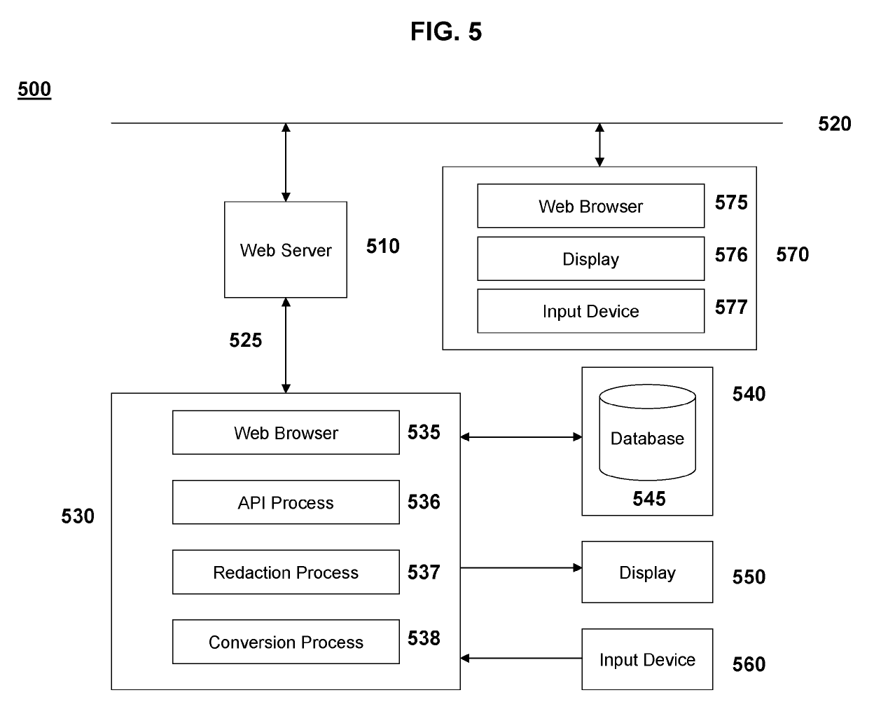

Turning now to FIG. 5, an alternative depiction of a system for managing confidential information is provided. Confidential information management system 500 may include Web server 510 which allows access to/from computer network 520, e.g., the Internet, via network connection 525.

Processor 530 may include various conventional processes and functionality associated with network and/or stand-alone computing, as well as various functionality associated with processes of the present disclosure. More than one processor 530 may be used. For example processor 530 may include including Web browser functionality 535, API process 536, redaction process 537, and conversion process 538. Web browser 535 may be a conventional web browser such as Internet Explorer® or Firefox®, and which is connected to the Internet via network connection 525. Although FIG. 5 implies use of the Internet, the system and method of the present disclosure may also be useful in a private network arrangement, and is not limited to the Internet. Web server node 510 may be implemented in a variety of ways known in the art to transfer information over a computer network.

Memory 540 may be connected to a standard manner with processor 530, and may include one or more structured databases 545. Memory 540 may be implemented in a variety of known ways, for example by a hard drive or removable storage or others storage devices. The data may be formatted in a desired manner that lends itself to be stored in a structured database. Multiple memories and/or backup memory storage may also be implemented, including use of an image server which is optimized or configured for more timely access to document images.

Display 550 and input device 560 may be conventional computer peripheral devices which have respective interfaces with processor 530 to allow input and display of data by a system manager and/or administrator (not shown).

A user, e.g., a job applicant (not shown), may be allowed access to information contained in database 545 via user workstation 570 and Web server 510, which are connected to network 520. User workstation 570 may include one or more processors (not shown) that implements functionality associated with web browser 575, display 576, and input device 577, for example. As mentioned above, the user's interface to documents stored in memory 540 may be enabled through an associated Web server in communication with the Internet.

The user, e.g., job applicant, may upload original text document 120, e.g., a resume, to memory 540 via Web server 510 and computer network 520. Processor 530 could then be configured to carry out the functionality associated with document Web service 110 as depicted in FIG. 1.

Web browser 575, when the user workstation 570 is logged into Web server 510, may offer interactive controls for navigating multiple pages and documents, at the discretion or desire of the user, and as allowed by the administrator of system 500. For example, and as mentioned above, system 500 may be a subscription-based job search system in which a job applicant or potential employer/recruiter is required to pay a fee for a particular service (e.g., searching for a job and/or posting a job) or for various services such as employment services offered over a period of time, for example. The level of services for which a user has access may depend on the particular type of subscription purchased, i.e., “premium” employment services may be offered at increased cost to the user.

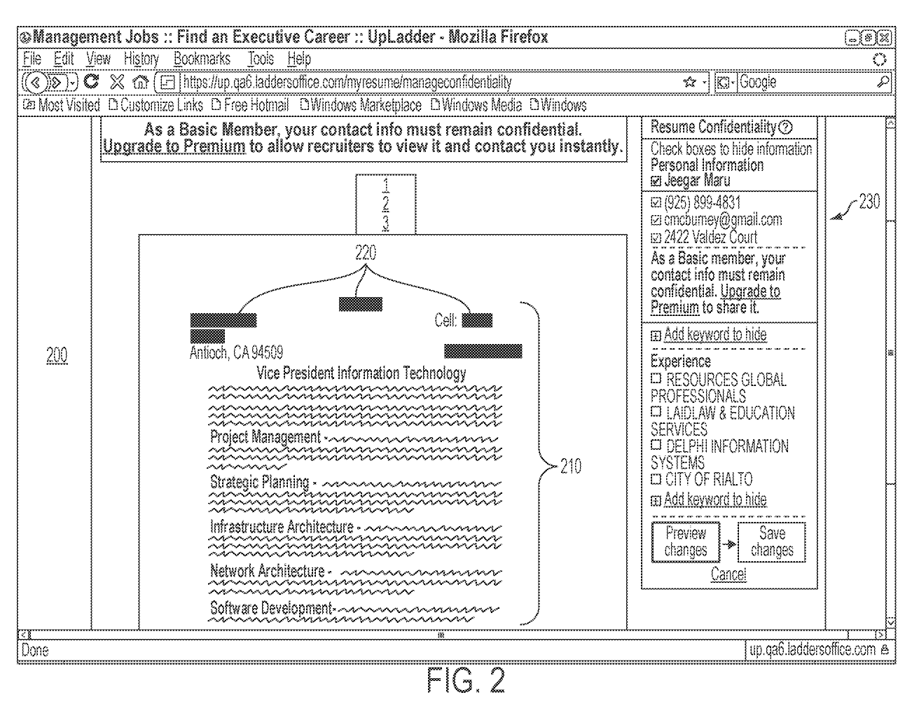

Turning now to FIG. 2, an exemplary embodiment of a screenshot 200 available to a properly logged in and authenticated user is provided. By way of example, a portion of a resume 210 is illustrated. The precise words associated with resume portion 210 shown in FIG. 2 are not critical to an understanding of the inventive concept. The black or opaque sections 220 illustrated areas where confidential information was contained in original text document 120, for example. As discussed above, confidential information may include a job applicant's name, telephone number, address, e-mail address, current employer, and/or past employment or other situationally-dependent information as selectively determined by the user.

Confidentiality management control panel 230 is seen at the right-side of screenshot 200. Through this graphical user interface (GUI), a user may select and/or deselect various items of personal information through the use of standard GUI buttons and/or checkboxes. Further, the user may selectively add additional items or keywords to the list of confidential information as desired or deemed necessary. In FIG. 2, the user only has a “basic” subscription, requiring that all contact information remain confidential. In another aspect of this embodiment, the user may be allowed to selectively allow one or more items of contact information to be displayed without redaction with or without purchase of a “premium” subscription or membership, for example.

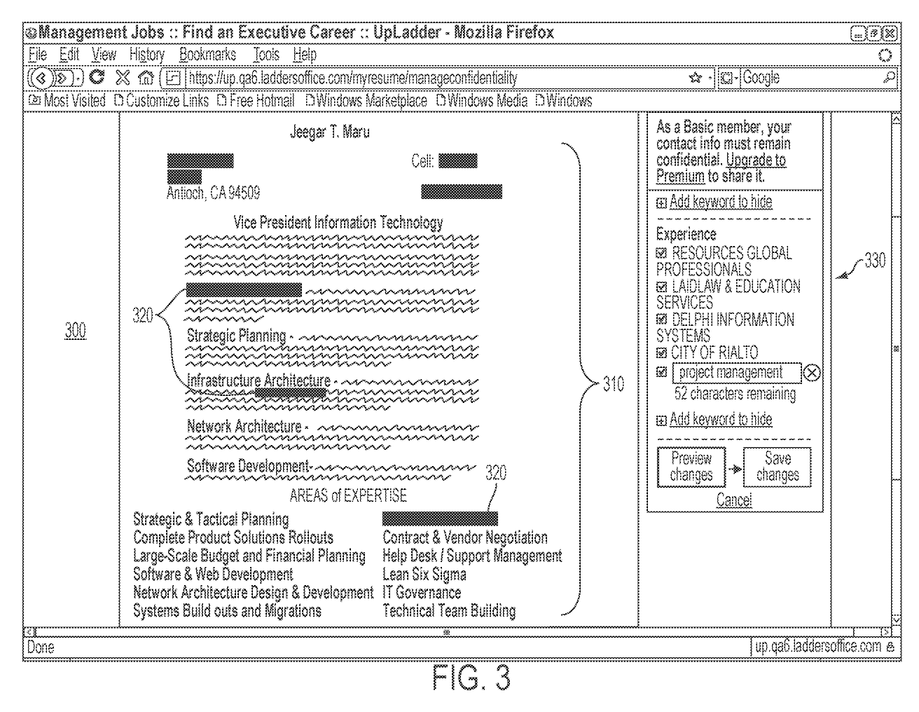

FIG. 3 depicts a portion of a resume 310, similar to resume portion 210 of FIG. 2. One difference between resume portion 310 and resume portion 210 is in the additional confidential information 320 that has been redacted/obscured by system 500 and/or document Web service 110. For example, additional confidential information 320 has been obscured by the user's selection of additional keywords in confidentiality management control panel 330. In this aspect, system 500 has identified previous employers and made them available as user-selectable confidential keywords. In addition, management control panel 330 also offers the ability for user-desired keywords and/or phrases to be entered and made confidential, and thus be obscured/redacted in resume portion 310.

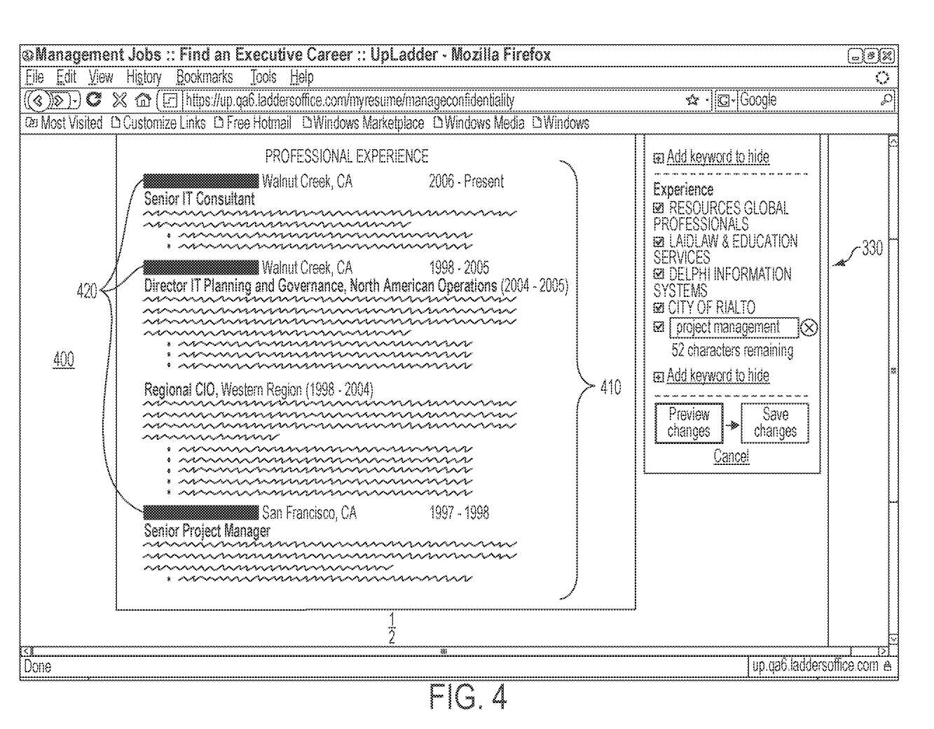

FIG. 4 illustrates a different page 410 of a document (e.g., a second page of a resume) in which further confidential information 420 has been obscured through a selection of keywords in control panel 330 (Note: control panel 330 is configured with the same keyword selection in FIGS. 3 and 4, although it does not have to be configured in the same manner).

In another embodiment depicted, at least in part, in FIGS. 1 and 5, a computer-implemented document browser application for designating and/or protecting confidential information in an original document by a user includes a processor configured to execute instructions such that a software interface with an Internet Web browser enables the application to run within a Web browser window. A user interface may be enabled with a host computer system through which the user sends a document retrieval request to a server application and inputs and/or selects one or more keywords representing associated confidential information in the original document. The user interface may include computer executable code therein which, when executed by the host computer system, enables a interactive graphical user interface that includes controls for selectively entering and/or selecting one or more keywords that represents confidential information.

As in other embodiments discussed above, retrieved documents may include a resume of a job applicant which contains personal information which may be considered confidential information.

The foregoing describes only various aspects of embodiments of the disclosure, and modifications, obvious to those skilled in the art, can be made thereto without departing from the spirit and scope of the disclosed and claimed invention.

What is claimed is:

1. A computer-implemented method of designating and/or protecting confidential information in an original document, the method comprising:
receiving a file containing the original document through a computer-network interface, said original document containing confidential information therein;
storing the original document in one or more structured databases configured in one or more memories operatively coupled to the computer-network interface through at least one processor;
providing a user interface between the at least one processor and the at least one user associated with the original document and identifying at least a portion of the information considered to be confidential through the user interface;
identifying, by the at least one processor, each occurrence of the confidential information contained in the original document;
generating one or more redacted files in which said each occurrence of the confidential information in the original document may selectively be obscured; and
storing said generated one or more redacted files in said one or more structured databases such that said one or more redacted files are available for selective retrieval by the at least one user and a different user.

2. The method of claim 1, further comprising selectively retrieving said or more redacted files by the different user through the computer-network interface.

3. The method of claim 1, wherein said one or more redacted files comprise corresponding one or more redacted image-based files stored in an image server accessible through the computer-network interface.

4. The method of claim 1, wherein said computer-network interface comprises an interface with the Internet.

5. The method of claim 1, wherein said generating one or more redacted files comprises:
storing a first redacted document in a first document format;
reading the first redacted document by the at least one processor; and
generating, by the at least one processor, one or more second image-based files in an image format using the first redacted document.

6. The method of claim 5, wherein the first document format comprises a portable document format (PDF) and said image format comprises a bit-mapped image format.

7. The method of claim 5, wherein said image format comprises a portable network graphics (PNG) format.

8. The method of claim 1, wherein said one or more redacted files comprises one or more portable network graphics (PNG) image files.

9. The method of claim 1, wherein said original document comprises a plurality of pages, and wherein each of said one or more redacted files comprise an image format file associated with a respective one of the plurality of pages.

10. The method of claim 1, wherein said user interface between the at least one processor and the at least one user is enabled through a web browser.

11. The method of claim 1, wherein said user interface between the at least one processor and the at least one user comprises a graphical user interface.

12. The method of claim 11, wherein said graphical user interface comprises a plurality of check boxes each configured to correspond to a keyword that relates to one item of the confidential information in the original document, wherein a selection of a keyword check box identifies corresponding confidential information to be redacted.

13. The method of claim 11, wherein said graphical user interface comprises an input area through which a keyword that relates to one item of the confidential information in the original document is entered by the at least one user.

14. The method of claim 1, wherein said receiving a file comprises uploading the document to a Web server over the Internet.

15. The method of claim 1, wherein the document comprises a resume of a job seeker.

16. The method of claim 1, wherein said generating one or more redacted files in which said each occurrence of the confidential information in the original document is obscured comprises replacing a keyword representing confidential information with one or more text symbols and an opaque overlay.

17. A computer-implemented system for designating and/or protecting confidential information in an original document, the system comprising:
at least one processor;
a computer-network interface operatively coupled to the at least one processor and configured to receive a file containing the original document from at least one user via a computer network, said original document containing confidential information therein;
one or more memory devices operatively coupled to the at least one processor, said one or more memory devices including one or more structured databases therein configured to store at least the original document;
a user interface operatively coupled to the at least one processor, said user interface being configured to provide, to the at least one processor, one or more inputs from the at least one user associated with the original document, said one or more inputs selectively identifying confidential information contained in the original document;
wherein said at least one processor is configured to:
identify each occurrence of the confidential information contained in the original document,
generate one or more redacted files in which said each occurrence of the confidential information in the original document may selectively be obscured, and
store said generated one or more redacted files in at least one of said one or more structured databases such that said one or more redacted files are available for selective retrieval by the at least one user and a different user via the computer network.

18. The system of claim 17, further comprising selectively retrieving said or more redacted files by the different user through the computer-network interface.

19. The system of claim 17, further comprising an image server coupled to the computer-network interface, wherein said one or more redacted files comprise corresponding one or more redacted image-based files.

20. The system of claim 17, wherein said computer-network comprises the Internet.

21. The system of claim 17, wherein said at least one processor is further configured to:
store a first redacted document in a first document format in said at least one of said one or more structured databases,
analyze the first redacted document,
generate, using the first redacted document, one or more second image-based files in an image format, and
store said one or more second image-based files in said at least one of said one or more structured databases.

22. The system of claim 21, wherein the first document format comprises a portable document format (PDF) and said image format comprises a bit-mapped image format.

23. The method of claim 21, wherein said image format comprises a portable network graphics (PNG) format.

24. The system of claim 17, wherein said one or more redacted files comprises one or more portable network graphics (PNG) image files.

25. The system of claim 17, wherein said original document comprises a plurality of pages, and wherein each of said one or more redacted files comprise an image format file associated with a respective one of the plurality of pages.

26. The system of claim 17, wherein said user interface between the at least one processor and the at least one user comprises a web browser.

27. The system of claim 17, wherein said user interface between the at least one processor and the at least one user comprises a graphical user interface.

28. The system of claim 27, wherein said graphical user interface comprises a plurality of check boxes each configured to correspond to a keyword that relates to one item of the confidential information in the original document, wherein a selection of a keyword check box by the at least one user identifies corresponding confidential information to be redacted.

29. The system of claim 27, wherein said graphical user interface comprises an input area through which a user-desired keyword that relates to one item of the confidential information in the original document is entered by the at least one user.

30. The system of claim 17, wherein said computer-network interface is operatively coupled to a Web server connected to the Internet, wherein the original document is uploaded to the Web server over the Internet.

31. The system of claim 17, wherein the document comprises a resume of a job seeker.

32. The system of claim 17, wherein said at least one processor is configured to generate one or more redacted files in which said each occurrence of the confidential information in the original document is obscured by replacing a keyword representing confidential information with one or more text symbols and an opaque overlay.

33. A computer-implemented document browser application for designating and/or protecting confidential information in an original document by a user, the application comprising:
a processor configured to execute instructions therein such that a software interface with an Internet Web browser enables the application to run within a Web browser window;
a user interface enabled with a host computer system through which the user inputs and/or selects one or more keywords representing associated confidential information in the original document,
said user interface comprising computer executable code therein which, when executed by the host computer system, enables a interactive graphical user interface comprising controls for selectively entering and/or selecting said one or more keywords.

34. The computer-implemented document browser application of claim 33, wherein said original document comprises a resume of a job seeker.

35. The method of claim 1, wherein said generating one or more redacted files in which said each occurrence of the confidential information in the original document may selectively be obscured comprises generating a file in which no confidential information is obscured.

36. The method of claim 1, wherein said identifying at least a portion of the information considered to be confidential is identified by the at least one user through the user interface.

37. The method of claim 1, wherein said identifying at least a portion of the information considered to be confidential is identified using one or more predetermined default types of information.

38. The system of claim 17, wherein said at least one processor is configured to generate a file in which no confidential information is obscured in response to an input from the at least one user via the user interface.

39. The system of claim 17, wherein said at least one processor is configured to identify at least a portion of the information considered to be confidential in response to one or more inputs from the at least one user through the user interface.

40. The system of claim 17, wherein said at least one processor is configured to identify at least a portion of the information considered to be confidential using one or more predetermined default types of information.
